(19) United States
(12) Patent Application Publication
(10) Pub. No.: US 2026/0201746 A1
(43) Pub. Date: Jul. 16, 2026

(54) VENETIAN BLIND STRUCTURE WITH TILTABLE LOWER RAIL

(71) Applicant: UNION WINNER INTERNATIONAL CO., LTD., TAIPEI CITY (TW)

(72) Inventor: Ming-Tsung PAI, CAOTUN TOWNSHIP (TW)

(73) Assignee: UNION WINNER INTERNATIONAL CO., LTD., TAIPEI CITY (TW)

(21) Appl. No.: 19/022,587

(22) Filed: Jan. 15, 2025

(51) Int. Cl. E06B 9/307; E06B 9/304; E06B 9/323; E06B 9/38

(52) U.S. Cl. CPC E06B 9/307; E06B 9/304; E06B 9/323; E06B 9/38

(57) ABSTRACT

A Venetian blind structure includes an upper rail, a lower rail, slats, a slat adjustment mechanism disposed inside the upper rail and provided with a mounting seat and a rotating shaft rotatably disposed at the mounting seat, a ladder cord unit, and a pull cord unit including first and second pull cords. The first pull cord has an end connected with the slat adjustment mechanism, and the other end connected with the lower rail. The second pull cord has an end fixed to the upper rail or the slat adjustment mechanism, and the other end connected to the lower rail in a way that when the slat adjustment mechanism operates, the portion of the first pull cord arranged in the slat adjustment mechanism is released or retracted, while the second pull cord remains stationary, thereby turning the slats and the lower rail.

### BACKGROUND OF THE INVENTION

### 1. Field of the Invention

The present invention relates generally to a Venetian blind structure and more particularly, to a Venetian blind structure with a tiltable lower rail. When the slats of the Venetian blind structure are driven to turn, the lower rail is turned in coordination with the slats, thereby achieving a complete blackout effect.

### 2. Description of the Related Art

Conventional Venetian blinds generally include an upper rail, a lower rail, and a plurality of vertical or horizontal slats installed between the upper rail and the lower rail. Users adjust the tilt angle of all the slats via a modulation device to regulate indoor light, thereby achieving effect of keeping privacy. As such, Venetian blinds are widely used in offices and homes. The lifting mechanism of a Venetian blind can be installed within the upper or lower rail. By simply pushing the lower rail upward, the lifting mechanism stacks and folds the slats sequentially from bottom to top, moving them near the upper rail, resulting in a state that the window is unblocked by the Venetian blind.

When adjusting the tilt angles of the slats, synchronized movement between the slats and the lower rail may not be achieved due to the grounds that the slats may not be arranged and aligned in good order, and the weight of the lower rail is typically greater than that of the slats. Consequently, when the Venetian blinds are adjusted to the fully closed position, irregular gaps, which will cause light leakage, often form between the slats or between the lower rail and the lowest slat, failing to achieve a complete blackout effect.

China Patent No. 109424308B discloses a Venetian blind having a lifting mechanism installed in the upper rail. The Venetian blind mainly includes an upper rail, a lower rail, a plurality of slats, a ladder cord, a first (front) pull cord, a second (rear) pull cord, a lifting module, a modulation mechanism, and an adjustment unit. The rear pull cord is driven by means of cord loop, gear mechanism, or belt transmission mechanism of the adjustment unit, enabling the lower rail to move upward at a certain distance to facilitate turning the lower rail. However, this design is not only structurally complex but also prone, after a long time use and repeat operations, to cause an issue that the initial position of the lower rail will be gradually raised to result in light leakage from the area below the lower rail, i.e. gradually reducing the light blocking range.

Accordingly, there is a need to provide a Venetian blind structure capable of turning both the slats and the lower rail synchronously, allowing all the slats and the lower rail to cooperatively block light after turning, thereby achieving a complete blackout effect.

### SUMMARY OF THE INVENTION

The present invention has been accomplished in view of the above-noted circumstances. It is an objective of the present invention to provide a Venetian blind structure with a tiltable lower rail, which enables the lower rail to tilt along with the slats, achieving a complete shading effect.

To attain the above objective, the present invention provides a Venetian blind structure, comprising an upper rail, a lower rail, a plurality of slats, at least one slat adjustment mechanism, at least one ladder cord unit, and at least one pull cord unit. The upper rail has a first accommodation. The lower rail is arranged opposite to the upper rail and has a second accommodation. The slats are arranged between the upper and lower rails. The slat adjustment mechanism is disposed in the first accommodation of the upper rail and comprises a mounting seat and a rotating shaft rotatably disposed with the mounting seat. The ladder cord unit is connected with the slat adjustment mechanism of the upper rail to the lower rail and is also connected with the slats. The pull cord unit comprises a first pull cord and a second pull cord. An end of the first pull cord is disposed with the slat adjustment mechanism, and the other end is disposed with the lower rail, such that the first pull cord is drivenable by the slat adjustment mechanism. An end of the second pull cord is fixed to the upper rail or the slat adjustment mechanism, and the other end is disposed with the lower rail in such a way that when the first pull cord is driven by the slat adjustment mechanism, the second pull cord remains stationary.

With the above-mentioned technical features, when the slat adjustment mechanism operates, both the ladder cord unit and the first pull cord are driven. The ladder cord unit is responsible for turning the slats to tilt, while the first pull cord tilts the lower rail. Since the end of the second pull cord is fixed to the upper rail or the slat adjustment mechanism, the second pull cord will not be driven by the operation of the slat adjustment mechanism. The first pull cord is released or retracted by the slat adjustment mechanism, causing a difference in length between the first and second pull cords as the slat adjustment mechanism operates. Based on the length variation of the first pull cord, the other end of the first pull cord drives the lower rail to tilt, allowing the lower rail to tilt together with the slats at a certain angle.

Preferably, the Venetian blind structure further comprises a modulation device and a transmission shaft. The modulation device is disposed at an end portion of the upper rail, and the transmission shaft is disposed in the first accommodation of the upper rail and extends through the modulation device and the rotating shaft of the slat adjustment mechanism. The modulation device provides a handle, enabling a user to operate the internal transmission mechanism of the modulation device by turning a connector, thereby driving the transmission shaft to rotate the rotating shaft of the slat adjustment mechanism, thereby pulling the first pull cord.

Preferably, the Venetian blind structure further comprises a lifting mechanism disposed in the second accommodation of the lower rail. The other ends of the first and second pull cords of the pull cord unit are disposed with the lifting mechanism. As such, when the lower rail moves upward, the lifting mechanism retracts the first and second pull cords, allowing the lower rail and the slats of the Venetian blind structure to be retracted near the upper rail. When the lower rail moves downward, the lifting mechanism releases the first and second pull cords, enabling the Venetian blind structure to be used for shading.

Preferably, the mounting seat of the slat adjustment mechanism is provided at a side thereof with at least one plug mount. The plug mount is provided at a center thereof with an accommodating groove, in which a first positioning plug is disposed. As such, the first positioning plug is arranged on the side of the mounting seat, allowing the second pull cord to be fixed within the plug mount without being affected by the operation of the rotating shaft.

Preferably, the first positioning plug of the slat adjustment mechanism has a hollow structure provided at an inner side thereof with a plurality of first positioning grooves. The end of the second pull cord is fixed to the first positioning plug, and the second pull cord is wound along the plurality of first positioning grooves. Thus, the second pull cord is secured to the first positioning plug in a wound manner, enabling the adjustment of the length of the second pull cord. Furthermore, when the first positioning plug is installed in the accommodating groove of the plug mount, the second pull cord is simultaneously fixed.

Preferably, the end of the first pull cord of the pull cord unit is fixed to the rotating shaft of the slat adjustment mechanism, enabling the first pull cord to be driven along with the rotation of the rotating shaft. As such, the end of the first pull cord, which is disposed with the slat adjustment mechanism, can be selectively fixed to the rotating shaft, allowing synchronous pulling of the first pull cord as the rotating shaft operates.

Preferably, the slat adjustment mechanism further comprises an adjustment unit disposed by a side of the mounting seat. The adjustment unit is operatively linked with the rotating shaft of the slat adjustment mechanism through a transmission shaft. The end of the first pull cord of the pull cord unit is fixed to the adjustment unit, allowing the first pull cord to be driven as the adjustment unit operates. As such, the end of the first pull cord, which is disposed with the slat adjustment mechanism, can be selectively fixed to the adjustment unit, allowing synchronous pulling of the first pull cord as the adjustment unit operates.

Preferably, the adjustment unit comprises a first transmission member and a second transmission member engaged with the first transmission member. The transmission shaft passes through the first transmission member. An end of the second transmission member is provided with a guide wheel and a second positioning plug disposed within the guide wheel. The end of the first pull cord of the pull cord unit is fixed to the guide wheel or the second positioning plug. As a result, the transmission shaft drives the first transmission member of the adjustment unit to rotate, which in turn drives the second transmission member to rotate. This causes the first pull cord, which is fixed to the guide wheel or the second positioning plug, to be pulled, such that the first pull cord is either wound onto the outer periphery of the guide wheel or released from the outer periphery of the guide wheel.

Preferably, the second positioning plug of the adjustment unit has a hollow structure provided at an inner side thereof with a plurality of second positioning grooves. The first pull cord is fixed to the second positioning plug and wound along the plurality of second positioning grooves. Thus, the first pull cord is secured to the second positioning plug in a wound manner, enabling the adjustment of the length of the first pull cord. Furthermore, when the second positioning plug is installed in the guide wheel, the first pull cord is simultaneously fixed.

Preferably, the center of the first transmission member is formed with an engaging hole, and the periphery of the engaging hole is formed with a first engaging portion and a second engaging portion, allowing the transmission shaft to pass through the engaging hole in an engaged or disengaged state. In this way, the structural shape of the transmission shaft is configured as being only engaged with the first engaging portion or the second engaging portion, so that when the transmission shaft rotates, it will not immediately drive the first transmission member but create a time of idle stroke.

Preferably, one end of each slat has a through hole, through which the ladder cord unit extends. In this way, the ladder cord unit is connected with the slats through the through holes, so that the slats may be fixed by the ladder cord unit to prevent the slats from shaking.

Preferably, the ladder cord unit comprises a first warp cord, a second warp cord, and a plurality of weft cords. The first warp cord and the second warp cord are arranged on front and rear sides of the slats, respectively. The first warp cord has an end disposed with the rotating shaft of the slat adjustment mechanism, and the second warp cord has an end disposed with the rotating shaft of the slat adjustment mechanism. The weft cords are connected with the first warp cord and the second warp cord and support bottom surfaces of the slats, respectively. As such, the first warp and the second warp will be respectively displaced up and down, i.e. generate a vertical offset therebetween, due to the operation of the slat adjustment mechanism, thereby driving the slats to tilt at a certain angle counterclockwise or clockwise.

Preferably, the first and second warp cords each have a plurality of ring portions. The first pull cord of the pull cord unit passes through the ring portions of the first warp cord, and the second pull cord of the pull cord unit passes through the ring portions of the second warp cord. The ring portions of the second warp cord pass through the through holes of the slats, respectively. As a result, the ring portions of the ladder cord unit will assist the movement of the pull cord unit and limit the displacement paths of the first pull cord and the second pull cord to avoid affecting the smooth operation of the Venetian blind structure.

Additionally, the present invention provides another Venetian blind structure, comprising an upper rail, a lower rail, a plurality of slats, at least one slat adjustment mechanism, at least one ladder cord unit, and at least one pull cord unit. The upper rail has a first accommodation. The lower rail is arranged opposite to the upper rail and has a second accommodation. The slats are arranged between the upper rail and the lower rail. The slat adjustment mechanism is disposed in the first accommodation of the upper rail and provided with a mounting seat, a rotating shaft rotatably disposed with the mounting seat, and an adjustment unit disposed by a side of the mounting seat and operatively linked with the rotating shaft. The ladder cord unit is connected with the slat adjustment mechanism to the lower rail, and connected with the slats. The pull cord unit includes a first pull cord and a second pull cord. The first pull cord has an end fixed to the adjustment unit of the slat adjustment mechanism, and the other end disposed with the lower rail. The second pull cord has an end disposed with the rotating shaft of the slat adjustment mechanism, and the other end disposed with the lower rail in a way that when the second pull cord is driven by the rotating shaft of the slat adjustment mechanism, the first pull cord is driven by the adjustment unit of the slat adjustment mechanism in a way that the first pull cord and the second pull cord are driven asynchronously.

With the above-mentioned technical features, when the slat adjustment mechanism operates, the ladder cord unit and the second pull cord are first driven. The ladder cord unit is responsible for turning the slats to tilt, while the second pull cord tilts the lower rail. As the slat adjustment mechanism operates, the second pull cord is released from or retracted onto the rotating shaft of the slat adjustment mechanism. Although the first pull cord is similarly driven by the adjustment unit, the activation timing of the first pull cord and the second pull cord is not synchronized. Furthermore, one end of the first pull cord is fixed to the adjustment unit, which limits the operating range of the first pull cord through the adjustment unit. This results in a gradual difference in length between the first pull cord and the second pull cord. Based on the change in the length of the second pull cord, the other end of the second pull cord drives the lower rail to turn, enabling the lower rail to tilt at an angle together with the slats.

The detailed structure, features, assembly, and usage of the Venetian Blind structure provided by the present invention will be described in detail in the following embodiments. However, those skilled in the art will understand that the specific embodiments and descriptions are intended to illustrate the invention and are not meant to limit the scope of the patent claims.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a Venetian Blind structure according to a first embodiment of the present invention, showing the slats and the lower rail at a first position;

FIG. 2 is a partially enlarged view of FIG. 1, showing the upper rail of the first embodiment of the present invention;

FIG. 3 is an exploded perspective view of the slat adjustment mechanism of the first embodiment of the present invention;

FIG. 4 is an enlarged perspective view, showing the ladder cord unit and pull cord unit of the first embodiment of the present invention;

FIG. 5 is an enlarged perspective view, showing structural relationship among the ladder cord unit, the pull cord unit and the slats;

FIG. 6 is an enlarged perspective view, showing structural relationship among the ladder cord unit, the pull cord unit and the slats from another viewing angle of FIG. 5;

FIG. 7 is similar to FIG. 1, but showing the slats and the lower rail at a second position;

FIG. 8 is a perspective view, showing an upper rail of a second embodiment of the present invention;

FIG. 9 is an exploded perspective view of the slat adjustment mechanism of the second embodiment of the present invention;

FIG. 10 is a perspective view, showing the ladder cord unit and the pull cord unit of the second embodiment of the present invention;

FIG. 11 is an enlarged lateral view of a part of the slat adjustment mechanism of the second embodiment of the present invention, showing the structural relationship between a transmission shaft and a first transmission member;

FIG. 12 is a perspective view of the Venetian Blind structure of the second embodiment of the present invention, showing the slats and the lower rail at a third position; and

FIG. 13 is a perspective view, showing a ladder cord unit and a pull cord unit in accordance with a third embodiment of the present invention.

### DETAILED DESCRIPTION OF THE INVENTION

It is to be firstly mentioned that in the following embodiments and drawings, identical reference numbers indicate identical or similar elements or structural features thereof. It should be noticed that for the convenience of illustration, the components and the structure shown in the figures are not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements.

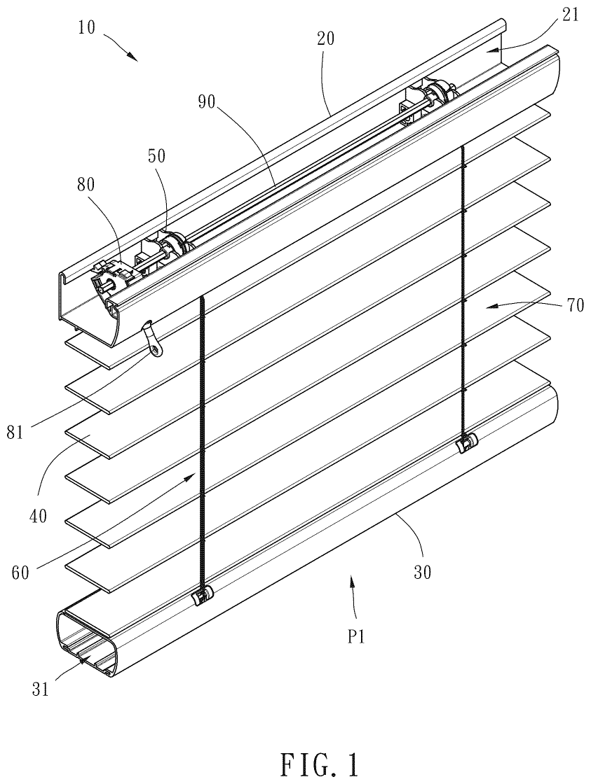

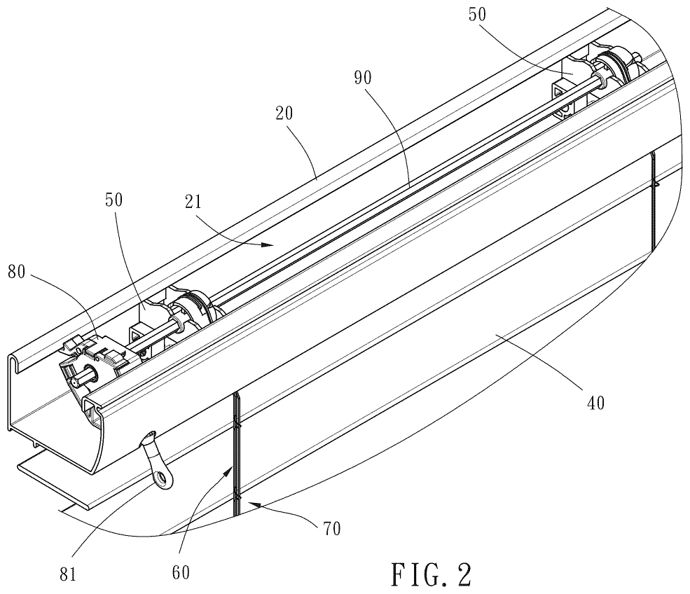

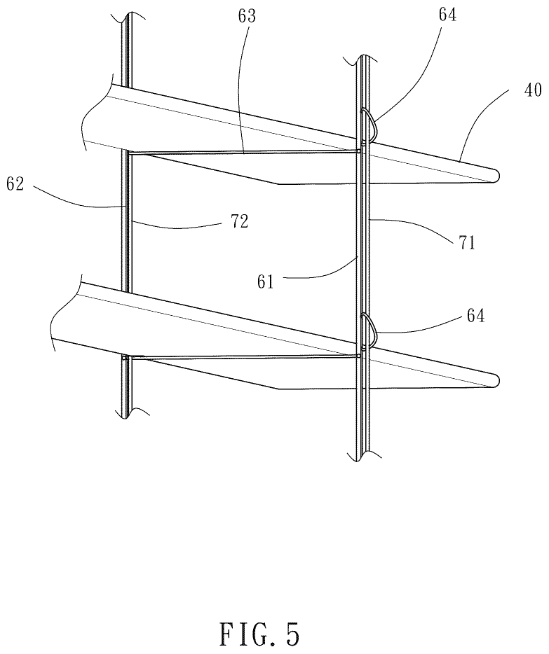

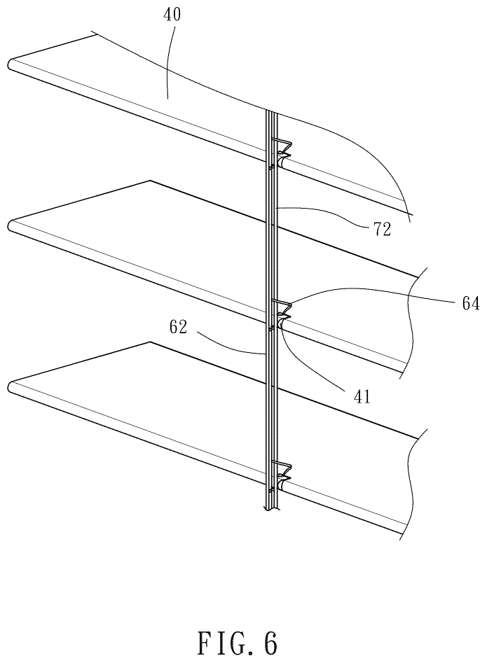

Referring to FIGS. 1 to 6, a Venetian blind structure 10 provided in accordance with a first embodiment of the present invention primarily includes an upper rail 20, a lower rail 30, a plurality of slats 40, at least one slat adjustment mechanism 50, at least one ladder cord unit 60, and at least one pull cord unit 70. Based on the dimensions of the Venetian blind structure 10, two slat adjustment mechanisms 50, two ladder cord units 60, and two pull cord units 70 are used as an embodiment in the following description.

The upper rail 20 is a rectangular frame body that has a first accommodation 21. A modulation device 80 and a transmission shaft 90 are both received in the first accommodation 21. The modulation device 80 is disposed at an end portion of the upper rail 20, and the transmission shaft 90, which has a hexagonal cross-section, extends through the modulation device 80. The modulation device 80 protrudes outward with a connector 81, which is connected to a handle (not shown). The user rotates the handle, causing the connector 81 to simultaneously drive an internal transmission mechanism (not shown), which in turn transmits rotational force to the transmission shaft 90.

The lower rail 30 is a rectangular frame body arranged opposite to or below the upper rail 20. The lower rail 30 includes a second accommodation 31, in which a lifting mechanism (not shown) is disposed.

The plurality of slats 40 are arranged between the upper rail 20 and the lower rail 30. Each slat 40 has a through hole 41 at one end. The ladder cord unit 60 passes through the through holes 41 of the slats 40, so that the ladder cord unit 60 can secure the positions of all the slats 40.

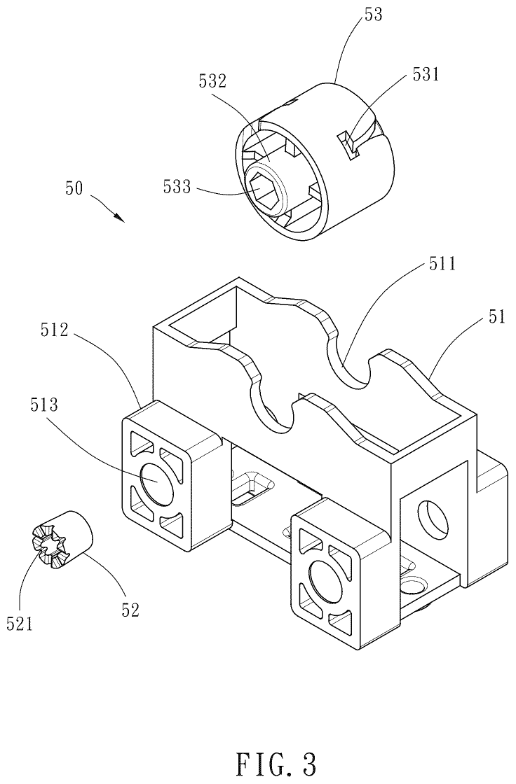

The slat adjustment mechanism 50 is disposed within the first accommodation 21 of the upper rail 20. As shown in FIG. 3, the slat adjustment mechanism 50 includes a mounting seat 51, a first positioning plug 52, and a rotating shaft 53. The mounting seat 51 is a bracket. The rotating shaft 53 is provided at the outer periphery with two cord notches 531, and at two sides with two protruded shaft portions 532. The rotating shaft 53 has a shaft hole 533 penetrating through the two sides thereof. The transmission shaft 90 extends through the shaft hole 533. The top of the mounting seat 51 is provided with two recesses 511 to accommodate the two shaft portions 532 of the rotating shaft 53, allowing the rotating shaft 53 to be rotatably disposed on the mounting seat 51. On a lateral side of the mounting seat 51, at least one plug mount 512 and one accommodating groove 513 are formed. In this embodiment, the mounting seat 51 includes four plug mounts 512, each having an accommodating groove 513 in the center thereof. The first positioning plug 52 is inserted into the accommodating groove 513. The first positioning plug 52 has a hollow structure with a plurality of first positioning grooves 521 formed on an inner side thereof.

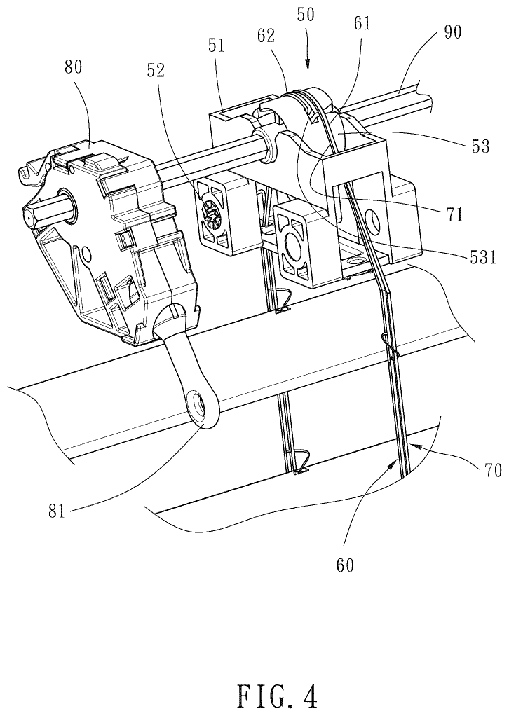

The ladder cord unit 60 includes a first warp cord 61, a second warp cord 62, and a plurality of weft cords 63. The first warp cord 61 is disposed on the front sides of the slats 40, facing the interior of the room as the front warp cord. The second warp cord 62 is disposed on the rear sides of the slats 40, facing the window as the rear warp cord. The upper ends of both the first warp cord 61 and the second warp cord 62 are fixed to the rotating shaft 53 of the slat adjustment mechanism 50, with parts of the first and second warp cords 61 and 62 hanging along (wound around) the outer periphery of the rotating shaft 53. The lower ends of both the first warp cord 61 and the second warp cord 62 are fixed to the lower rail 30. Beneath each slat 40, two weft cords 63 are arranged to support the bottom surface of the slat 40 in such a way that two ends of each weft cord 63 are connected to the first warp cord 61 and the second warp cord 62, respectively. The first warp cord 61 and the second warp cord 62 each have multiple ring portions 64 evenly spaced along their length. The ring portions 64 of the second warp cord 62 are inserted through corresponding through holes 41 of the slats 40, respectively. In this way, the ladder cord unit 60 achieves positioning and support of the slats 40, as shown in FIGS. 4 to 6.

The pull cord unit 70 includes a first pull cord 71 and a second pull cord 72. The first pull cord 71 is positioned on the front sides of the slats 40, serving as the front pull cord facing the interior of the room. The upper end of the first pull cord 71 is fixed in the cord notch 531 of the rotating shaft 53 of the slat adjustment mechanism 50, while the lower end is connected to the lifting mechanism in the lower rail 30. The first pull cord 71 also passes through the ring portions 64 of the first warp cord 61 of the ladder cord unit 60. The second pull cord 72 is positioned on the rear sides of the slats 40, serving as the rear pull cord facing the window. The upper end of the second pull cord 72 is selectively fixed to either the upper rail 20 or the first positioning plug 52, primarily to ensure that the second pull cord 72 remains stationary and cannot be pulled. In the first embodiment, the second pull cord 72 is wound along the first positioning grooves 521 of the first positioning plug 52 of the slat adjustment mechanism 50. The first positioning plug 52 is then placed into the accommodating groove 513, securing both the first positioning plug 52 and the second pull cord 72 to the mounting seat 51. The lower end of the second pull cord 72 is connected to the lifting mechanism in the lower rail 30, and the second pull cord 72 also passes through the ring portions 64 of the second warp cord 62 of the ladder cord unit 60, as shown in FIGS. 4 to 6.

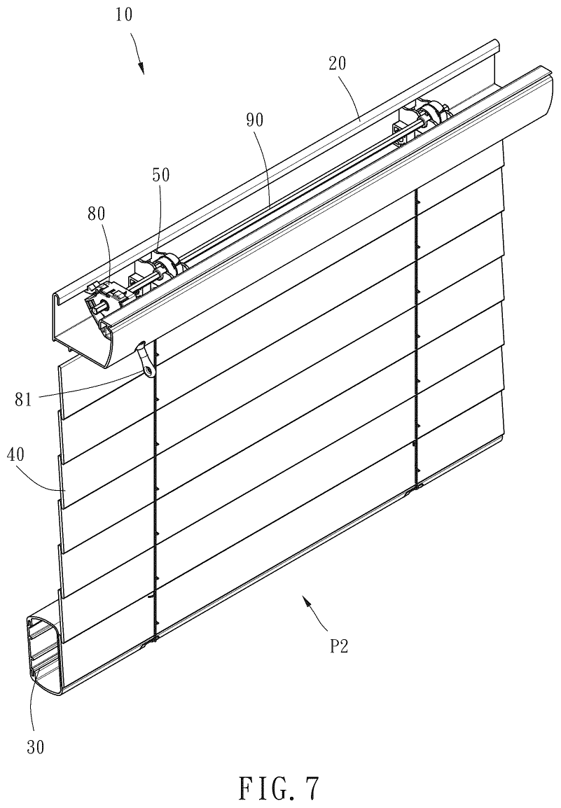

FIG. 1 shows that the slats 40 and the lower rail 30 of the Venetian blind structure 10 of the first embodiment stays at the first position P1, where the slats 40 are parallel to the upper rail 20 and the lower rail 30, allowing light to stream into the interior of the room. In contrast, FIG. 7 shows that the slats 40 and the lower rail 30 of the Venetian blind structure 10 stays at the second position P2, where the slats 40 and the lower rail 30 are almost perpendicular to the upper rail 20, thereby blocking light from entering the interior of the room.

To adjust the Venetian blind structure to the fully light-blocking state, i.e. to change the slats 40 and the lower rails 30 from the first position P1 shown in FIG. 1 to the second position P2 shown in FIG. 7, the user rotates the handle of the modulation device 80 clockwise, causing the connector 81 to rotate simultaneously. In this way, the transmission mechanism inside the modulation device 80 will drive the transmission shaft 90 to rotate clockwise. The rotational force is then transmitted to the rotating shaft 53 of the slat adjustment mechanism 50, causing the rotating shaft 53 to rotate clockwise relative to the mounting seat 51. As the rotating shaft 53 rotates, the first warp cord 61, originally wound along be the outer periphery of the rotating shaft 53, begins to be released, while the second warp cord 62 will be wound onto the outer periphery of the rotating shaft 53. Consequently, the first warp cord 61 moves downward, and the second warp cord 62 moves upward, causing an up-and-down offset therebetween. This offset causes the weft cords 63, which connect the first warp cord 61 and the second warp cord 62, to tilt, such that the slats 40 are simultaneously driven by the first warp cord 61, the second warp cord 62, and the weft cords 63, to turn at an angle. As the user continues to rotate the handle, the tilt angle of the slats 40 gradually increases until the slats 40 reach the second position P2 shown in FIG. 7. At this position, the slats 40 partially overlap with each other, achieving a fully light-blocking effect.

With the rotation of the rotating shaft 53 of the slat adjustment mechanism 50, the first pull cord 71, originally disposed along the outer periphery of the rotating shaft 53, also begins to unwind and release. Since the upper end of the second pull cord 72 is fixed to the first positioning plug 52, the second pull cord 72 remains stationary and does not move along with the operation of the rotating shaft 53. At this time, the length of the first pull cord 71 increases as the first pull cord 71 releases from the rotating shaft 53, while the second pull cord 72 retains its original length. When the length of the first pull cord 71 exceeds that of the second pull cord 72, the end of the lower rail 30 where the first pull cord 71 is connected tilts downward. This means that the lower rail 30 turns about the position where the second pull cord 72 is fixed as the fulcrum. The lower rail 30 will continuously turn until it flips to the rear sides of the slats 40 and stays at the second position P2 shown in FIG. 7, achieving a fully light-blocking effect.

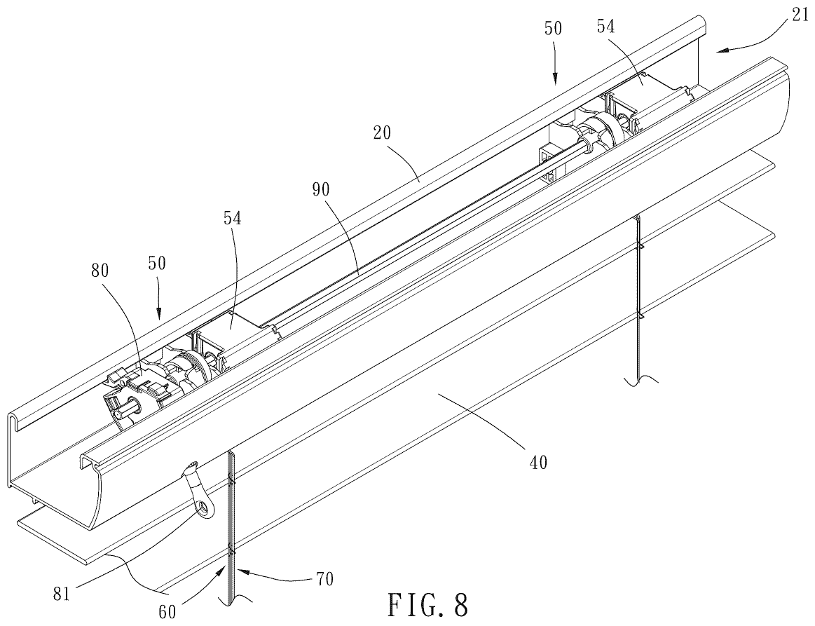

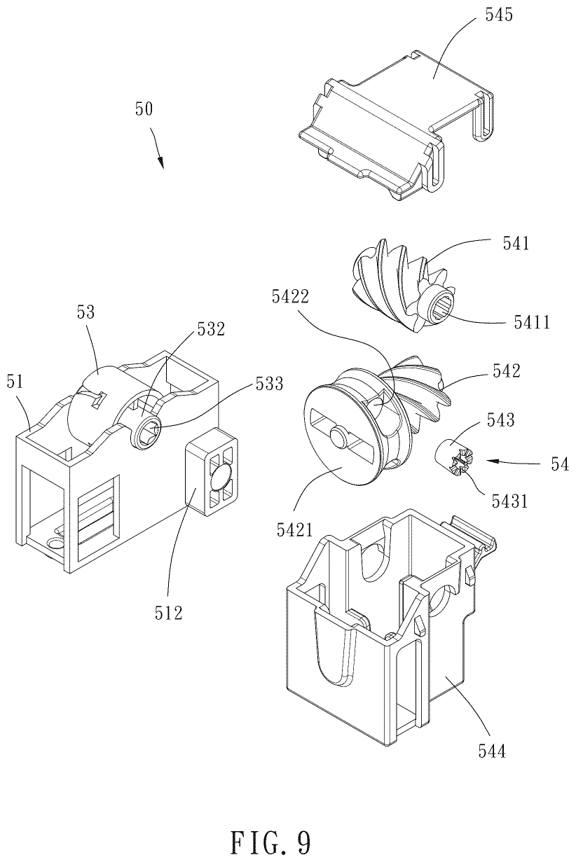

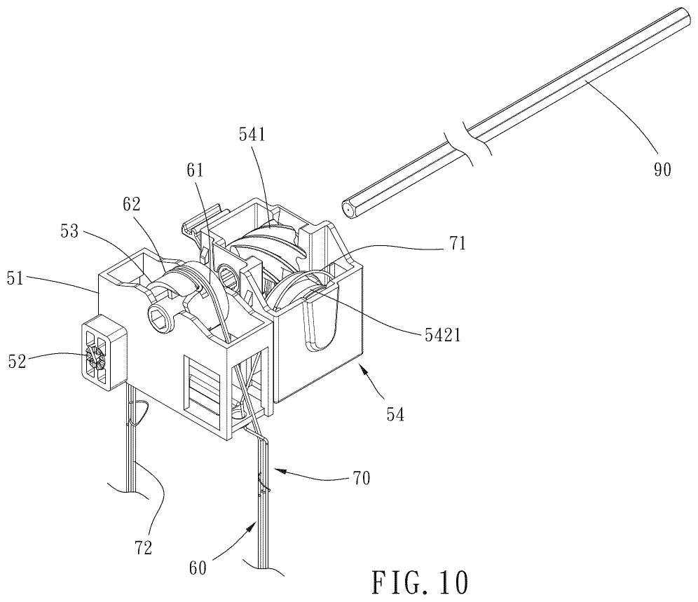

FIGS. 8 to 11 show a Venetian blind structure in accordance with a second embodiment of the present invention, which is structurally different from the Venetian blind structure of the first embodiment in the slat adjustment mechanism 50. The slat adjustment mechanism 50 provided by the second embodiment further includes an adjustment unit 54 positioned by one side of the mounting seat 51. The adjustment unit 54 includes a first transmission member 541 and a second transmission member 542. The first transmission member 541 may be, for example, a helical gear, with an engaging hole 5411 formed at its center. A first engaging portion 5412 and a second engaging portion 5413 are formed around the engaging hole 5411. The transmission shaft 90 passes through the engaging hole 5411. The second transmission member 542 may be, for example, a helical rack, with one end forming a guide wheel 5421, in which a second positioning plug 543 is disposed. The second positioning plug 543 has a hollow structure, with multiple second positioning grooves 5431 formed on its inner side. The upper end of the first pull cord 71 is fixed to either the guide wheel 5421 or the second positioning plug 543, allowing the first pull cord 71 to operate along with the guide wheel 5421. In the second embodiment, the first pull cord 71 is wound along the second positioning grooves 5431 of the second positioning plug 543. The second positioning plug 543 is then inserted in a mounting groove 5422 of the guide wheel 5421, securing both the second positioning plug 543 and the first pull cord 71 to the guide wheel 5421. The first pull cord 71 is subsequently wound along the outer periphery of the guide wheel 5421. The first transmission member 541 and the second transmission member 542 are received inside a housing 544 of the adjustment unit 54 and are covered by a cover 545 assembled on the top side of the housing 544. The structures of other components in the second embodiment are the same as those in the first embodiment and will not be redundantly described.

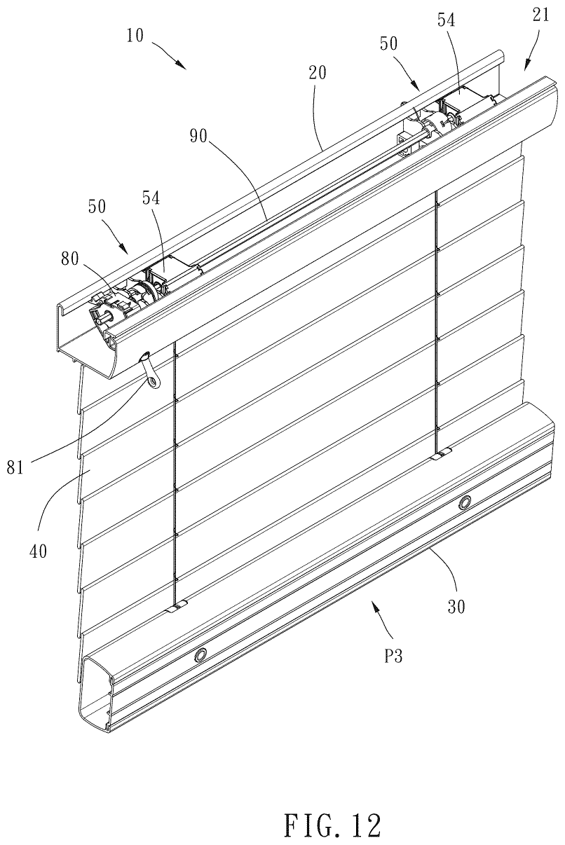

To adjust the Venetian blind structure of the second embodiment to a fully light-blocking state, i.e., to change the slats 40 and the lower rails 30 from the first position P1 shown in FIG. 1 to the third position P3 shown in FIG. 12, the user counterclockwise rotates the handle of the modulation device 80, causing the connector 81 to rotate simultaneously. In this way, the transmission mechanism inside the modulation device 80 will drive the transmission shaft 90 to rotate counterclockwise. The rotational force is then transmitted to both the rotating shaft 53 of the slat adjustment mechanism 50 and the first transmission member 541 of the adjustment unit 54, causing both the rotating shaft 53 and the first transmission member 541 to rotate counterclockwise. At the rotating shaft 53 rotates, the first warp cord 61 begins to be wound onto the outer periphery of the rotating shaft 53, while the second warp cord 62, originally wound along the outer periphery of the rotating shaft 53, is released. As a result, the first warp cord 61 moves upward, and the second warp cord 62 moves downward, causing an up-and-down offset therebetween. This offset causes the weft cords 63, which connect the first warp cord 61 and the second warp cord 62, to tilt, such that the slats 40 are simultaneously driven by the first warp cord 61, the second warp cord 62, and the weft cords 63 to turn at an angle. As the user continues to rotate the handle, the tilt angle of the slats 40 gradually increases until the slats 40 reach the third position P3 shown in FIG. 12, where the slats 40 partially overlap with each other, achieving a fully light-blocking effect.

With the rotation of the first transmission member 541 of the slat adjustment mechanism 50, the second transmission member 542 and the guide wheel 5421 installed at one end of the second transmission member 542 simultaneously rotate clockwise. Consequently, the first pull cord 71 starts to wind around the outer periphery of the guide wheel 5421, while the upper end of the second pull cord 72, which is fixed to the first positioning plug 52, remains stationary without moving. At this time, the length of the first pull cord 71 decreases as the first pull cord 71 is wound, while the length of the second pull cord 72 remains unchanged. When the length of the first pull cord 71 becomes shorter than that of the second pull cord 72, the end of the lower rail 30 where the first pull cord 71 is connected begins to lift upward. This means that the lower rail 30 turns about the position where the second pull cord 72 is fixed as a fulcrum. The lower rail 30 will continuously turn until it flips to the front sides of the slats 40 and stays at the third position P3 shown in FIG. 12, achieving a fully light-blocking effect.

Furthermore, if the user rotates the handle of the modulation device 80 clockwise, the guide wheel 5421 of the adjustment unit 54 of the slat adjustment mechanism 50 will rotate counterclockwise. This causes the first pull cord 71, originally wound around the outer periphery of the guide wheel 5421, to be released. The end of the lower rail 30 where the first pull cord 71 is connected will then tilt downward, causing the Venetian blind structure 10 to transition from the first position P1 shown in FIG. 1 to the second position P2 shown in FIG. 7.

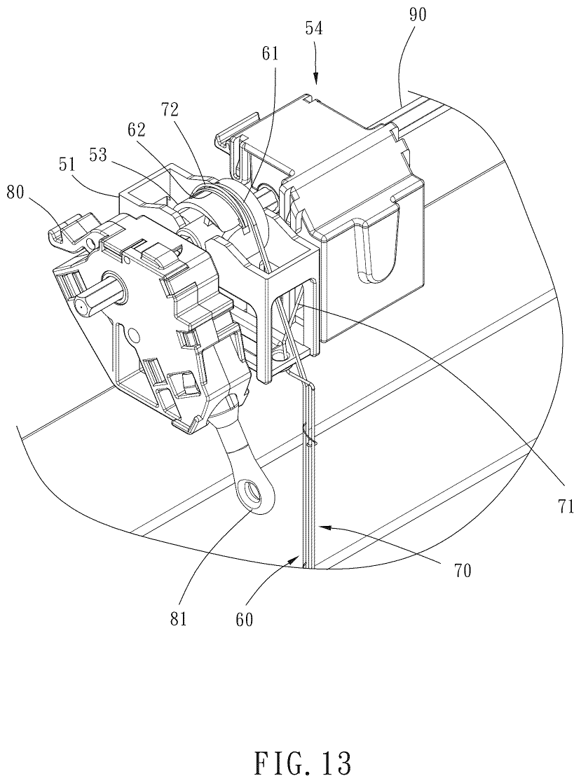

Additionally, FIG. 13 shows a Venetian blind structure in accordance with a third embodiment of the present invention, which is structurally difference from that of the second embodiment in the fixed position of the pull cord unit 70. In the third embodiment, the upper end of the second pull cord 72 is fixed to the cord notch 531 of the rotating shaft 53 of the slat adjustment mechanism 50. The other structural components of the third embodiment are identical to those of the second embodiment and will not be redundantly described.

To adjust the Venetian blind structure of the third embodiment to a fully light-blocking state, i.e., to change the slats 40 and the lower rails 30 from the first position P1 shown in FIG. 1 to the second position P2 shown in FIG. 7, the user rotates the handle of the modulation device 80 clockwise, causing the connector 81 to rotate simultaneously. In this way, the transmission mechanism inside the modulation device 80 will drive the transmission shaft 90 to rotate clockwise. The rotational force is then transmitted to the rotating shaft 53 of the slat adjustment mechanism 50 and the first transmission member 541 of the adjustment unit 54, causing both the rotating shaft 53 and the first transmission member 541 to rotate clockwise. As the rotating shaft 53 rotates, the first warp cord 61 is released, while the second warp cord 62, originally wound along the outer periphery of the rotating shaft 53, begins to be wound onto the outer periphery of the rotating shaft 53. As a result, the first warp cord 61 moves downward, and the second warp cord 62 moves upward, causing an up-and-down offset therebetween. This offset causes the weft cords 63, which connect the first warp cord 61 and the second warp cord 62, to tilt, such that the slats 40 are simultaneously driven by the first warp cord 61, the second warp cord 62, and the weft cords 63 to turn at an angle. As the user continues to rotate the handle, the tilt angle of the slats 40 gradually increases until the slats 40 reach the second position P2 shown in FIG. 7, where the slats 40 partially overlap with each other, achieving a fully light-blocking effect.

With the rotation of the first transmission member 541 of the slat adjustment mechanism 50, the second transmission member 542 and the guide wheel 5421 installed at one end of the second transmission member 542 simultaneously rotate counterclockwise. Consequently, the first pull cord 71 begins to be released from the guide wheel 5421, while the upper end of the second pull cord 72, which is fixed to the rotating shaft 53, is wound onto the outer periphery of the rotating shaft 53. When the first pull cord 71 is completely released, as its upper end is fixed to the second positioning plug 543, its length will no longer extend. Meanwhile, the second pull cord 72 shortens as it continues to be wound. When the length of the second pull cord 72 becomes shorter than that of the first pull cord 71, the end of the lower rail 30 where the second pull cord 72 is connected begins to lift upward. This means that the lower rail 30 turns about the position where the first pull cord 71 is fixed as a fulcrum. The lower rail 30 will continuously turn until it flips to the rear sides of the slats 40 and stays at the second position P2 shown in FIG. 7, achieving a fully light-blocking effect.

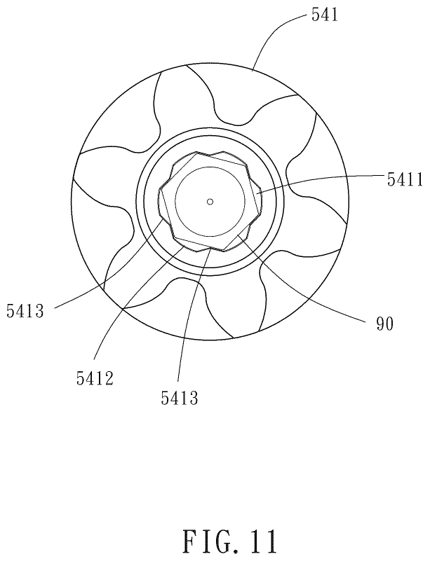

Furthermore, in the second embodiment and the third embodiment, the adjustment unit 54 of the slat adjustment mechanism 50 includes a first transmission member 541 having an engaging hole 5411. Surrounding the engaging hole 5411 are formed alternately-arranged first engaging portions 5412 and second engaging portions 5413. When the hexagonal shape of the transmission shaft 90 is in contact with the second engaging portion 5413, the transmission shaft 90 and the first transmission member 541 are in an engaged state, such that the first transmission member 541 can be driven by the transmission shaft 90 to rotate. However, when the hexagonal shape of the transmission shaft 90 is positioned at the location of the first engaging portion 5412, the transmission shaft 90 does not contact the first transmission member 541, resulting in a disengaged state between the transmission shaft 90 and the first transmission member 541, as shown in FIG. 11, such that the first transmission member 541 cannot be driven by the transmission shaft 90 to rotate. With this structural design, the transmission shaft 90 produces an idle stroke when it first rotates to a position relative to the first engaging portion 5412. It only begins to drive the first transmission member 541 to rotate when it reaches the second engaging portion 5413. This indicates that when the rotating shaft 53 begins to rotate, the adjustment unit 54 does not immediately actuate. The activation times of the first pull cord 71 and the second pull cord 72 are asynchronous. This delayed activation function allows the user to operate the modulation device 80 without needing a larger initial force to simultaneously drive the rotating shaft 53 and the first transmission member 541, making the design more labor-saving.

In conclusion, the Venetian blind structure 10 with a tiltable lower rail 30 provided by the present invention adopts the design that one ends of the first pull cord 71 and the second pull cord 72 are fixed to different components, while the other ends are both fixed to the lower rail 30. When the slat adjustment mechanism 50 is actuated, the first pull cord 71 and the second pull cord 72 produce an up-and-down offset therebetween, causing the lower rail 30 to tilt. This prevents light leakage gaps between the lower rail 30 and the slats 40. Compared with prior art, the present invention achieves a more complete light-blocking effect.

Finally, it should be noted that the components disclosed in the previous embodiments of the present invention are provided for illustrative purposes only and are not intended to limit the scope of the invention. Substitutions or modifications of other equivalent components should also be considered within the scope of the claims of the present invention.

What is claimed is:

1. A Venetian blind structure, comprising:
an upper rail having a first accommodation;
a lower rail arranged opposite to the upper rail and having a second accommodation;
a plurality of slats arranged between the upper rail and the lower rail;
at least one slat adjustment mechanism disposed in the first accommodation of the upper rail and provided with a mounting seat and a rotating shaft rotatably disposed with the mounting seat;
at least one ladder cord unit connected with the slat adjustment mechanism, the lower rail, and the slats; and
at least one pull cord unit comprising a first pull cord and a second pull cord;
wherein the first pull cord has an end disposed with the slat adjustment mechanism, and the other end disposed with the lower rail in a way that the first pull cord is drivenable by the slat adjustment mechanism;
wherein the second pull cord has an end fixed to the upper rail or the slat adjustment mechanism, and the other end disposed with the lower rail in a way that when the first pull cord is driven by the slat adjustment mechanism, the second pull cord remains stationary.

2. The Venetian blind structure as claimed in claim 1, further comprising a modulation device and a transmission shaft; wherein the modulation device is disposed at an end portion of the upper rail, and the transmission shaft is disposed in the first accommodation of the upper rail and extends through the modulation device and the rotating shaft of the slat adjustment mechanism.

3. The Venetian blind structure as claimed in claim 1, further comprising a lifting mechanism disposed in the second accommodation of the lower rail; wherein the other ends of the first pull cord and the second pull cord of the pull cord unit are disposed with the lifting mechanism.

4. The Venetian blind structure as claimed in claim 1, wherein the mounting seat of the slat adjustment mechanism is provided at a side thereof with at least one plug mount; the plug mount is provided at a center thereof with an accommodating groove, in which a first positioning plug is disposed.

5. The Venetian blind structure as claimed in claim 4, wherein the first positioning plug is of a hollow structure provided at an inner side thereof with a plurality of first positioning grooves; the end of the second pull cord is fixed to the first positioning plug, and the second pull cord is wound along the first positioning grooves.

6. The Venetian blind structure as claimed in claim 1, wherein the end of the first pull cord of the pull cord unit is fixed to the rotating shaft of the slat adjustment mechanism, such that the first pull cord is driven as the rotating shaft rotates.

7. The Venetian blind structure as claimed in claim 1, wherein the slat adjustment mechanism further comprises an adjustment unit disposed by a side of the mounting seat; the adjustment unit is operatively linked with the rotating shaft of the slat adjustment mechanism through a transmission shaft; the end of the first pull cord of the pull cord unit is fixed to the adjustment unit, such that the first pull cord is driven as the adjustment unit operates.

8. The Venetian blind structure as claimed in claim 7, wherein the adjustment unit comprises a first transmission member and a second transmission member engaged with the first transmission member; the transmission shaft extends through the first transmission member; the second transmission member is provided at an end thereof with a guide wheel and a second positioning plug disposed in the guide wheel; the end of the first pull cord of the pull cord unit is fixed to the guide wheel or the second positioning plug.

9. The Venetian blind structure as claimed in claim 8, wherein the second positioning plug of the adjustment unit is of a hollow structure provided at an inner side thereof with a plurality of second positioning grooves; the end of the first pull cord is fixed to the second positioning plug, and the first pull cord is wound along the second positioning grooves.

10. The Venetian blind structure as claimed in claim 8, wherein the first transmission member is provided at a center thereof with an engaging hole, and a first engaging portion and a second engaging portion formed around the engaging hole; the transmission shaft passes through the engaging hole in either an engaged state where the first transmission member is drivenable by the transmission shaft to rotate as the transmission shaft rotates or a disengaged state where the first transmission member is not drivenable by the transmission shaft to rotate as the transmission shaft rotates.

11. The Venetian blind structure as claimed in claim 1, wherein each of the slats is provided at an end thereof with a through hole, through which the ladder cord unit extends.

12. The Venetian blind structure as claimed in claim 11, wherein the ladder cord unit comprises a first warp cord, a second warp cord, and a plurality of weft cords; the first warp cord and the second warp cord are arranged on front and rear sides of the slats, respectively; the first warp cord has an end disposed with the rotating shaft of the slat adjustment mechanism, and the second warp cord has an end disposed with the rotating shaft of the slat adjustment mechanism; the weft cords are connected with the first warp cord and the second warp cord and support bottom surfaces of the slats, respectively.

13. The Venetian blind structure as claimed in claim 12, wherein the first warp cord and the second warp cord each have a plurality of ring portions; the first pull cord of the pull cord unit passes through the ring portions of the first warp cord, the second pull cord of the pull cord unit passes through the ring portions of the second warp cord, and the ring portions of the second warp cord pass through the through holes of the slats, respectively.

14. A Venetian blind structure, comprising:
an upper rail having a first accommodation;
a lower rail arranged opposite to the upper rail and having a second accommodation;
a plurality of slats arranged between the upper rail and the lower rail;
at least one slat adjustment mechanism disposed in the first accommodation of the upper rail and provided with a mounting seat, a rotating shaft rotatably disposed with the mounting seat, and an adjustment unit disposed by a side of the mounting seat and operatively linked with the rotating shaft;
at least one ladder cord unit connected with the slat adjustment mechanism, the lower rail, and the slats; and
at least one pull cord unit comprising a first pull cord and a second pull cord;
wherein the first pull cord has an end fixed to the adjustment unit of the slat adjustment mechanism, and the other end disposed with the lower rail;
wherein the second pull cord has an end disposed with the rotating shaft of the slat adjustment mechanism, and the other end disposed with the lower rail in a way that when the second pull cord is driven by the rotating shaft of the slat adjustment mechanism, the first pull cord is driven by the adjustment unit of the slat adjustment mechanism, and the first pull cord and the second pull cord are driven asynchronously.

15. The Venetian blind structure as claimed in claim 14, further comprising a modulation device and a transmission shaft; wherein the modulation device is disposed at an end portion the upper rail, and the transmission shaft is disposed in the first accommodation of the upper rail and extends through the modulation device and the rotating shaft of the slat adjustment mechanism.

16. The Venetian blind structure as claimed in claim 14, further comprising a lifting mechanism disposed in the second accommodation of the lower rail; wherein the other ends of the first pull cord and the second pull cord of the pull cord unit are disposed with the lifting mechanism.

17. The Venetian blind structure as claimed in claim 14, wherein the adjustment unit is operatively linked with the rotating shaft of the slat adjustment mechanism through a transmission shaft; the adjustment unit comprises a first transmission member and a second transmission member engaged with the first transmission member; the transmission shaft extends through the first transmission member; the second transmission member is provided at an end thereof with a guide wheel and a second positioning plug disposed within the guide wheel; the end of the first pull cord of the pull cord unit is fixed to the guide wheel or the second positioning plug.

18. The Venetian blind structure as claimed in claim 17, wherein the second positioning plug of the adjustment unit is of a hollow structure provided at an inner side thereof with a plurality of second positioning grooves; the end of the first pull cord is fixed to the second positioning plug, and the first pull cord is wound along the second positioning grooves.

19. The Venetian blind structure as claimed in claim 17, wherein the first transmission member is provided at a center thereof with an engaging hole, and a first engaging portion and a second engaging portion formed around the engaging hole; the transmission shaft passes through the engaging hole in either an engaged state where the first transmission member is drivenable by the transmission shaft to rotate as the transmission shaft rotates or a disengaged state where the first transmission member is not drivenable by the transmission shaft to rotate as the transmission shaft rotates.

20. The Venetian blind structure as claimed in claim 14, wherein each of the slats is provided at an end thereof with a through hole, through which the ladder cord unit extends.

21. The Venetian blind structure as claimed in claim 20, wherein the ladder cord unit comprises a first warp cord, a second warp cord, and a plurality of weft cords; the first warp cord and the second warp cord are respectively arranged on front and rear sides of the slats, respectively; the first warp cord has an end disposed with the rotating shaft of the slat adjustment mechanism, and the second warp cord has an end disposed with the rotating shaft of the slat adjustment mechanism; the weft cords are connected with the first warp cord and the second warp cord and support bottom surfaces of the slats, respectively.

22. The Venetian blind structure as claimed in claim 21, wherein the first warp cord and the second warp cord each have a plurality of ring portions; the first pull cord of the pull cord unit passes through the ring portions of the first warp cord, the second pull cord of the pull cord unit passes through the ring portions of the second warp cord, and the ring portions of the second warp cord pass through the through holes of the slats, respectively.
